(19) United States
(12) Patent Application Publication
(10) Pub. No.: US 2026/0278924 A1
(43) Pub. Date: Sep. 17, 2026

(54) USING GENERATIVE AI TO CREATE RICH SCENES WITHIN VIRTUAL ENVIRONMENTS

(71) Applicant: Rec Room Inc., Seattle, WA (US)

(72) Inventors: Nicholas Fajt, Seattle, WA (US); Cameron Brown, Seattle, WA (US); Dan Kroymann, Seattle, WA (US); Omer Bilal Orhan, Seattle, WA (US)

(73) Assignee: Rec Room Inc., Seattle, WA (US)

(21) Appl. No.: 19/566,873

(22) Filed: Mar. 13, 2026

Related U.S. Application Data
(60) Provisional application No. 63/772,327, filed on Mar. 14, 2025.

(51) Int. Cl. G06T 17/00; G06T 19/00

(52) U.S. Cl. CPC G06T 17/00; G06T 19/006; G06T 2200/08

(57) ABSTRACT

In some embodiments, a computer-implemented method of creating a scene within an area of a virtual environment is provided. A computing system receives a natural language prompt to create the scene in the area of the virtual environment. The computing system determines a multi-step plan for creating the scene. Determining the multi-step plan includes determining, by the computing system, one or more general tasks for creating the scene; and determining, by the computing system, one or more tool invocations for accomplishing each general task of the one or more general tasks. The computing system executes the one or more tool invocations to accomplish the one or more general tasks, thereby creating the scene within the area of the virtual environment.

### CROSS-REFERENCE TO RELATED APPLICATION

This application claims the benefit of Provisional Application No. 63/772327, filed Mar. 14, 2025, the entire disclosure of which is hereby incorporated by reference herein for all purposes.

### BACKGROUND

Virtual environments, in which a three-dimensional virtual world is presented to one or more users, are becoming increasingly popular. In many virtual environments, users are presented a first-person viewpoint, and navigate within the virtual environment using a variety of input devices. One continuing technical difficulty in providing rich interactivity within virtual environments is that the input hardware (e.g., motion controllers, pointers, etc.) is optimized for navigating within the virtual environment, and is not optimized for accepting detailed input from a user. As such, new techniques are desired that allow for hands-free creation of objects and scenes within the virtual environment in order to overcome the deficiencies in the input hardware.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method of creating a scene within an area of a virtual environment is provided. A computing system receives a natural language prompt to create the scene in the area of the virtual environment. The computing system determines a multi-step plan for creating the scene. Determining the multi-step plan includes determining, by the computing system, one or more general tasks for creating the scene; and determining, by the computing system, one or more tool invocations for accomplishing each general task of the one or more general tasks. The computing system executes the one or more tool invocations to accomplish the one or more general tasks, thereby creating the scene within the area of the virtual environment.

In some embodiments, a computer-implemented method of creating or updating objects within a virtual environment is provided. A computing system receives a natural language prompt to create or update an object in the virtual environment. The computing system generates a list of one or more relevant tool functions with inputs based on the natural language prompt. The computing system executes the list of the one or more relevant tool functions.

In some embodiments, a system is provided that comprises an endpoint system and a VR platform computing system. The endpoint system includes a display device and at least one handheld controller device, and is configured to present an area of a virtual environment using the display device. The VR platform computing system includes at least one processor and a non-transitory computer-readable medium having computer-executable instructions stored thereon. The instructions, in response to execution by the at least one processor, cause the VR platform computing system to perform actions for creating a scene within the area of the virtual environment presented by the endpoint system, the actions comprising: receiving, by the VR platform computing system from the endpoint system, a natural language prompt to create the scene in the area of the virtual environment; determining, by the VR platform computing system, a multi-step plan for creating the scene, wherein the multi-step plan includes: determining, by the VR platform computing system, one or more general tasks for creating the scene; and determining, by the VR platform computing system, one or more tool invocations for accomplishing each general task of the one or more general tasks; and executing, by the VR platform computing system, the one or more tool invocations to accomplish the one or more general tasks, thereby creating the scene within the area of the virtual environment.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an illustration of an example embodiment of a shared virtual environment according to various aspects of the present disclosure.

FIG. 2 is an illustration of a user interacting with an example embodiment of an endpoint system according to various aspects of the present disclosure.

FIG. 3 is a block diagram that illustrates an example embodiment of an endpoint system according to various aspects of the present disclosure.

FIG. 4 is a block diagram that illustrates aspects of a non-limiting example embodiment of a VR platform computing system according to various aspects of the present disclosure.

FIG. 5 is a flowchart that illustrates a non-limiting example embodiment of a method of creating a scene within an area of a virtual environment, according to various aspects of the present disclosure.

FIGS. 6A-6B are a flowchart that illustrates a non-limiting example embodiment of a procedure for determining and executing a plan for implementing a characteristic of a scene within a virtual environment, according to various aspects of the present disclosure.

### DETAILED DESCRIPTION

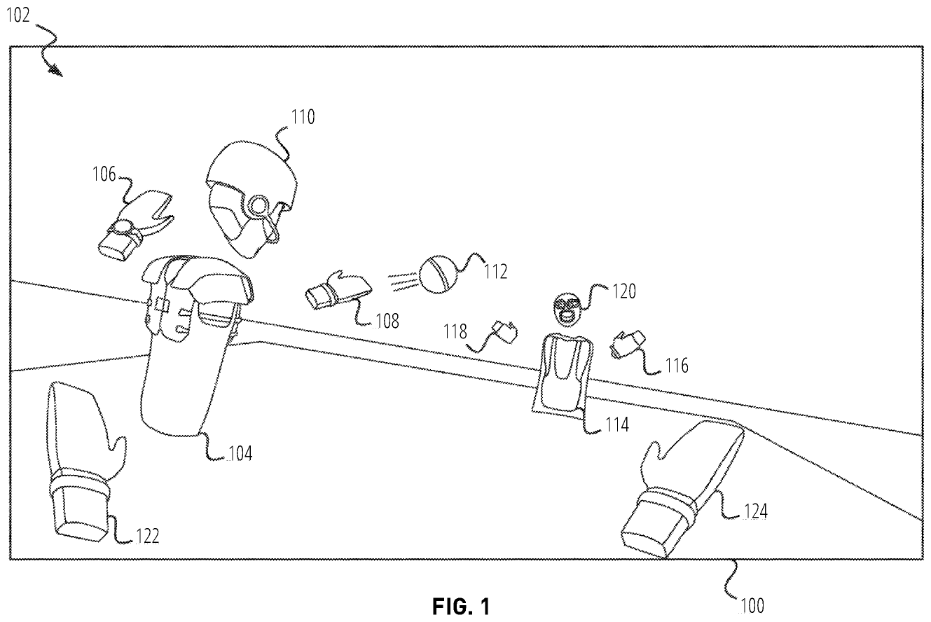

FIG. 1 is an illustration of an example embodiment of a shared virtual environment according to various aspects of the present disclosure. In FIG. 1, a display 100 of a head-mounted display device is illustrated, showing a view of a shared virtual environment 102 presented to a user via the head-mounted display device. The shared virtual environment 102 is a virtual room in which two or more users may interact with each other and/or with objects within the shared virtual environment through avatars. As shown, the view is a first-person view of the shared virtual environment 102, and two avatars can be seen. A first avatar has a head 110, a torso 104, a left hand 106 and a right hand 108. A second avatar also has a head 120, a left hand 116, a right hand 118, and a torso 114. In the illustrated scene, the first avatar has just thrown a ball 112 towards the second avatar. Because the scene is a first-person view, the user can also see a left hand 122 and a right hand 124 that correspond to the user's own avatar. This scene is an illustrative example to establish context for the rest of the disclosure, and should not be seen as limiting to any specific type of avatar, object, or virtual room or scene.

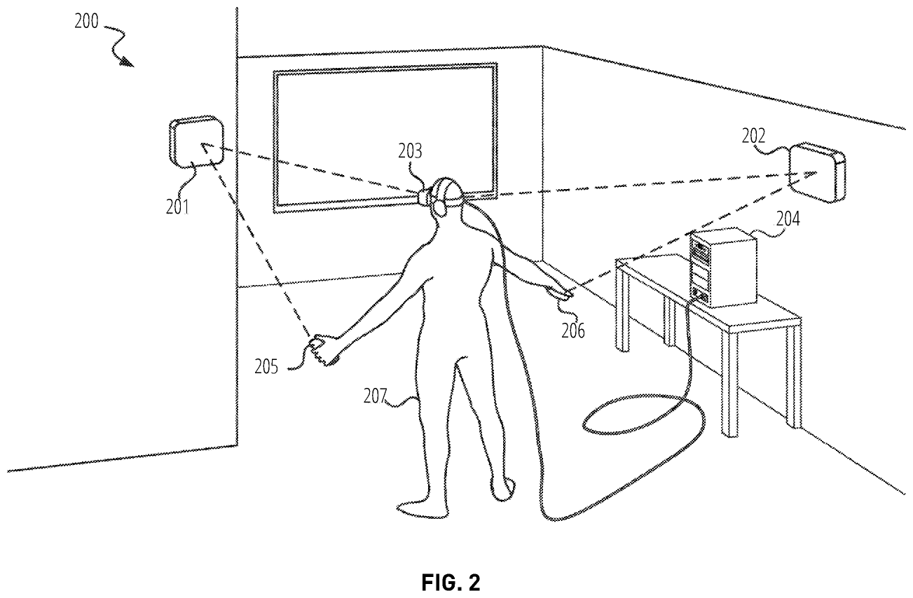

Each avatar in the shared virtual environment is associated with an endpoint system. FIG. 2 is an illustration of a user interacting with an example embodiment of an endpoint system according to various aspects of the present disclosure. The user 207 is in a room 200 that has been configured with an endpoint system. An endpoint computing device 204 is connected to a head-mounted display device 203 worn by the user 207 via a cable. The user 207 holds a first handheld controller device 205 in one hand, and a second handheld controller device 206 in the other hand. One or more motion sensor devices 201, 202 are arranged around the room 200, and detect the position and/or motion of the head-mounted display device 203 and the handheld controller devices 205, 206 within the room 200. The endpoint computing device 204 may use the detected positions and/or motions of the handheld controller devices 205, 206 to control the left hand 122 and the right hand 124 of the avatar of the user 207 within the shared virtual environment 102. The endpoint computing device 204 may use the detected positions and/or motions of the head-mounted display device 203 to move the avatar associated with the endpoint system within the shared virtual environment 102, and to move the viewpoint rendered by the head-mounted display device 203 within the shared virtual environment 102.

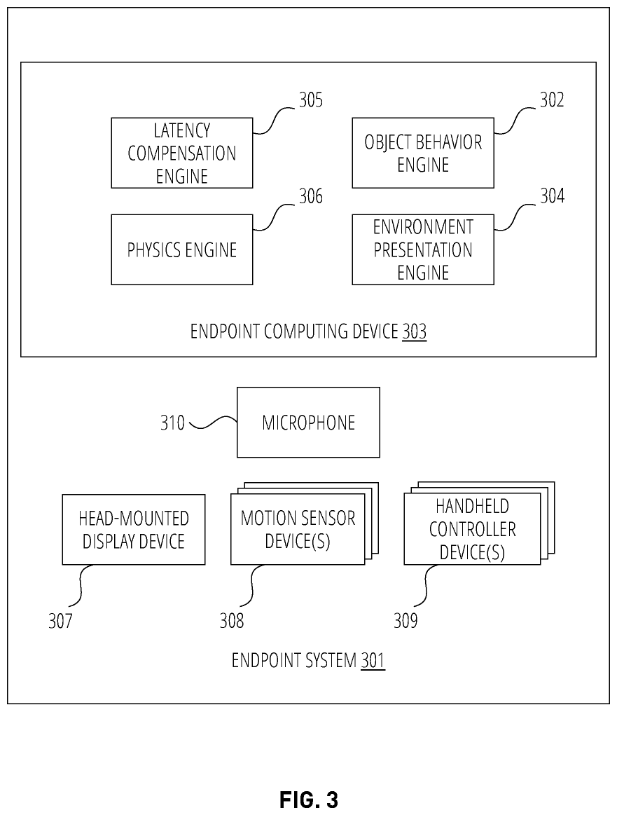

FIG. 3 is a block diagram that illustrates an example embodiment of an endpoint system according to various aspects of the present disclosure. In the illustrated embodiment, the endpoint system 301 includes an endpoint computing device 303, a microphone 310, a head-mounted display device 307, one or more motion sensor devices 308, and one or more handheld controller devices 309.

In some embodiments, the endpoint computing device 303 may be a desktop computing device, a laptop computing device, a tablet computing device, a mobile computing device, or any other type of computing device capable of executing the functionality described herein. The endpoint computing device 303 may have a significant amount of computing and graphic presentation power in order to be able to both execute all of the engines and drive the presentation on the head-mounted display device 307 at a consistently high frame rate. To provide this power, the endpoint computing device 303 may have specialized processors, such as a dedicated graphics card, a physics processing unit, and/or the like.

In some embodiments, the head-mounted display device 307 includes one or more screens, and is configured to be worn on a user's head such that an immersive view of the screens is provided. The head-mounted display device 307 may also include one or more speakers (such as headphones or the like) to provide an audio presentation as well as the video presentation provided by the one or more screens. In some embodiments, the handheld controller devices 309 include one or more input devices such as buttons, trackpads, directional pads, analog sticks, capacitive sensors, and the like. In some embodiments, one of the input devices of the handheld controller devices 309 may be a trigger button. In some embodiments, the handheld controller devices 309 may detect finger states or positions without requiring buttons to be actuated. In some embodiments that are referred to as virtual reality, the head-mounted display device 307 may be opaque, and the screens are the only thing that the user sees during use. In some embodiments that are referred to as augmented reality, the head-mounted display device 307 may have a translucent or transparent display screen, and may allow the user to see objects in the real world along with the objects in the shared virtual environment.

In some embodiments, the microphone 310 may be positioned within the endpoint system 301 in order to receive voice input from the user 207. In some embodiments, a single microphone 310 may be present. In some embodiments, multiple microphones 310 may be present in order to collect position or direction information regarding received audio input. While illustrated as a separate part of the endpoint system 301, in some embodiments, the microphone 310 (or microphones 310) may be embedded in one of the other devices of the microphone 310 (e.g., in the head-mounted display device 307 or the endpoint computing device 303, etc.).

In some embodiments, the motion sensor devices 308 independently detect motion of one or more of the head-mounted display device 307, the handheld controller devices 309, and the user. The motion sensor devices 308 may use any suitable technology to detect the motion, including but not limited to accelerometers, magnetometers, gyroscopes, infrared lasers, depth cameras, photosensors, and computer vision. In some embodiments, multiple motion sensor devices 308 may be located around a room in which the endpoint system 301 is located in order to detect the motion of the head-mounted display device 307, the handheld controller devices 309, and/or the user. In some embodiments, at least some of the motion sensor devices 308 may be incorporated into other devices (such as an accelerometer, magnetometer, and/or gyroscope integrated within the head-mounted display device 307 or handheld controller devices 309.

In some embodiments, the endpoint computing device 303 may be communicatively coupled to the head-mounted display device 307, the motion sensor device 308, and the handheld controller devices 309 using any suitable communication technology. For example, for the connections between the endpoint computing device 303 and the head-mounted display device 307 or the motion sensor device 308, high reliability and bandwidth may be desired, and so a suitable high-bandwidth wired communication technique (such as USB 3.0, Thunderbolt, Ethernet, and/or the like) may be used. As another example, for the connections between the endpoint computing device 303 and the handheld controller devices 309, mobility may be a greater concern than bandwidth, and so a wireless communication technique (such as Bluetooth, WiFi, radio frequency (RF) communication, and/or the like) may be used.

In some embodiments, the endpoint computing device 303 is responsible for generating the presentation of the shared virtual environment to the user, for managing the behavior of objects within the shared virtual environment as presented to the user, and for communicating state updates and other environment information with a VR platform computing system and other endpoint systems. In the illustrated embodiment, the endpoint computing device 303 is configured to provide a latency compensation engine 305, a physics engine 306, and an environment presentation engine 304 in order to provide this functionality, though in other embodiments, different components may be used by the endpoint computing device 303 in order to generate the presentation of the shared virtual environment.

In some embodiments, the environment presentation engine 304 generates presentations of objects in the shared virtual environment to the user. In some embodiments, the environment presentation engine 304 may generate at least one video feed that includes the presentation of the objects, and provides the at least one video feed to the head-mounted display device 307 to be displayed. In some embodiments, the environment presentation engine 304 may also generate at least one audio feed to be presented via the head-mounted display device 307.

In some embodiments, the physics engine 306 provides a real-time simulation of physical behavior of the objects in the shared virtual environment. As known to one of ordinary skill in the art, a physics engine 306 may provide the simulation by conducting collision detection/collision response actions, rigid body and/or soft body dynamics, fluid dynamics, and/or other processing to determine how objects would interact within the shared virtual environment. In some embodiments, the physics engine 306 may be implemented in software executing on a CPU of the endpoint computing device 303, in software executing in a hardware-accelerated manner on a graphics processing unit (GPU), in dedicated hardware such as a physics processing unit (PPU), or in any combination thereof. Some nonlimiting examples of physics engines 306 that may be suitable for use with the endpoint system 301 include the PhysX engine by Nvidia, the Havok engine by Microsoft Corporation, and the open source Bullet engine.

In some embodiments, the object behavior engine 302 may determine non-physical behavior of objects within the shared virtual environment. As some non-limiting examples of non-physical behavior, the object behavior engine 302 may determine permissions for interacting with an object, may change object states based on game rules or logic, and may detect meaning embedded in interactions detected by the physics engine 306 and respond accordingly (e.g., providing logic that detects collaborative gestures based on object collisions; determining that a collision between a first object and a second object, such as a Frisbee and a target, indicates that a goal in a game has been achieved, and so on).

In some embodiments, the engines of the endpoint computing device 303 may manage the shared virtual environment using a model-view-controller paradigm. That is, for any given object within the shared virtual environment, a data structure representing a model of the object is maintained by the endpoint computing device 303. The latency compensation engine 305, physics engine 306, and object behavior engine 302 make changes to the model of the object and therefore act as controllers. The environment presentation engine 304 generates a presentation based on the model of the object, and therefore acts as a view. In some embodiments, other software design paradigms may be used, and so the functionality described below may be split differently, or may be performed by different engines. In some embodiments, the engines described herein may be combined with each other. In some embodiments, multiple copies of a single engine may be present. In some embodiments, functionality described as originating from a given engine may in other embodiments be performed by a different engine.

In some embodiments, some of the devices illustrated in FIG. 3 may be combined with other devices, or some components may be in different devices than illustrated in FIG. 3. For example, in some embodiments, the physics engine 306 and/or the environment presentation engine 304 may be provided by dedicated devices separate from the endpoint computing device 303, or may be provided by the head-mounted display device 307. In some embodiments, the motion sensor device 308 may track the hands of the user accurately enough to allow the handheld controller devices 309 to be omitted. The below description may refer to embodiments that use handheld controller devices 309 for the sake of clarity. However, the description should not be seen as limiting the disclosure this embodiment, and should instead be seen as encompassing embodiments wherein the handheld controller devices 309 are missing and corresponding user input is obtained through the motion sensor device 308 alone.

In some embodiments, commercially available hardware may be used for the head-mounted display device 307, the motion sensor device 308, and the handheld controller devices 309. Some nonlimiting examples of such hardware include the Rift headset and Touch controllers from Oculus VR, LLC; the HTC Vive headset and SteamVR controllers from HTC and Valve Corporation; and the HoloLens headset from Microsoft Corporation. While these examples are provided, one of ordinary skill in the art will understand that the examples are not intended to be limiting, but that other hardware from other manufacturers may instead be used in some embodiments of the present disclosure.

While FIGS. 2-3 primarily illustrate and describe embodiments that use a head-mounted display device and handheld controller devices, these embodiments are examples only, and in other embodiments, different devices may be used. For example, in some embodiments, the endpoint system may be implemented by a mobile computing device (e.g., a smartphone or a tablet computing device). In such embodiments, the virtual environment may be presented on a display of the computing device. Movement of the viewpoint may be tied to motion sensor devices within the mobile computing device, and/or input on a touchscreen of the mobile computing device. Likewise, instead of triggers or other buttons on the handheld controller devices 309, other input may be received via a touchscreen of the mobile computing device.

Regardless of the form factor of the endpoint system 301, each embodiment shares a common technical hurdle: since traditional input devices for complex input (e.g., a keyboard and mouse) are unavailable, it is exceedingly difficult to provide input to the endpoint system 301 that would be useful to create new and complex scenes within the virtual environment. While a microphone 310 is available on the microphone 310, there is not currently a way of processing voice input received by the microphone 310 to create such complex content. What is desired are techniques that can use voice input to create complex scenes within the virtual environment.

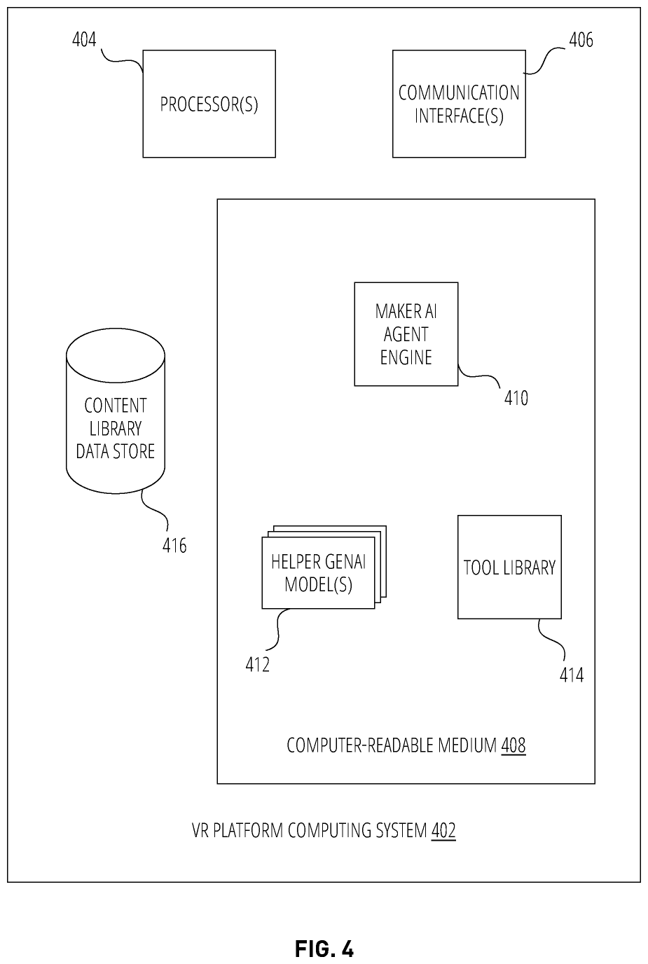

FIG. 4 is a block diagram that illustrates aspects of a non-limiting example embodiment of a VR platform computing system according to various aspects of the present disclosure. The illustrated VR platform computing system 402 may be implemented by any computing device or collection of computing devices, including but not limited to a desktop computing device, a laptop computing device, a mobile computing device, a server computing device, a computing device of a cloud computing system, and/or combinations thereof. The VR platform computing system 402 is configured to provide the ability to process voice prompts received from endpoint systems, and to create complex scenes within the virtual environment based on the voice prompts.

As shown, the VR platform computing system 402 includes one or more processors 404, one or more communication interfaces 406, a content library data store 416, and a computer-readable medium 408.

In some embodiments, the processors 404 may include any suitable type of general-purpose computer processor. In some embodiments, the processors 404 may include one or more special-purpose computer processors or AI accelerators optimized for specific computing tasks, including but not limited to graphical processing units (GPUs), vision processing units (VPUs), and tensor processing units (TPUs).

In some embodiments, the communication interfaces 406 include one or more hardware and or software interfaces suitable for providing communication links between components. The communication interfaces 406 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As shown, the computer-readable medium 408 has stored thereon logic that, in response to execution by the one or more processors 404, cause the VR platform computing system 402 to provide a maker AI agent engine 410. In some embodiments, the maker AI agent engine 410 may be configured to use one or more artificial intelligence models to process prompts received from endpoint systems 301 to create complex scenes within the virtual environment. In some embodiments, the maker AI agent engine 410 may use one or more artificial intelligence models to generate plans for creating scenes, and may invoke one or more helper GenAI models 412 to accomplish specific steps of the plans. In some embodiments, the maker AI agent engine 410 may invoke tools in a tool library 414 provided by the VR platform computing system 402 to execute actions within the virtual environment related to creating the scene. Further description of the configuration of each of these components is provided below.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

As used herein, “engine” refers to logic embodied in hardware or software instructions, which can be written in one or more programming languages, including but not limited to C, C++, C #, COBOL, JAVA™, PHP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

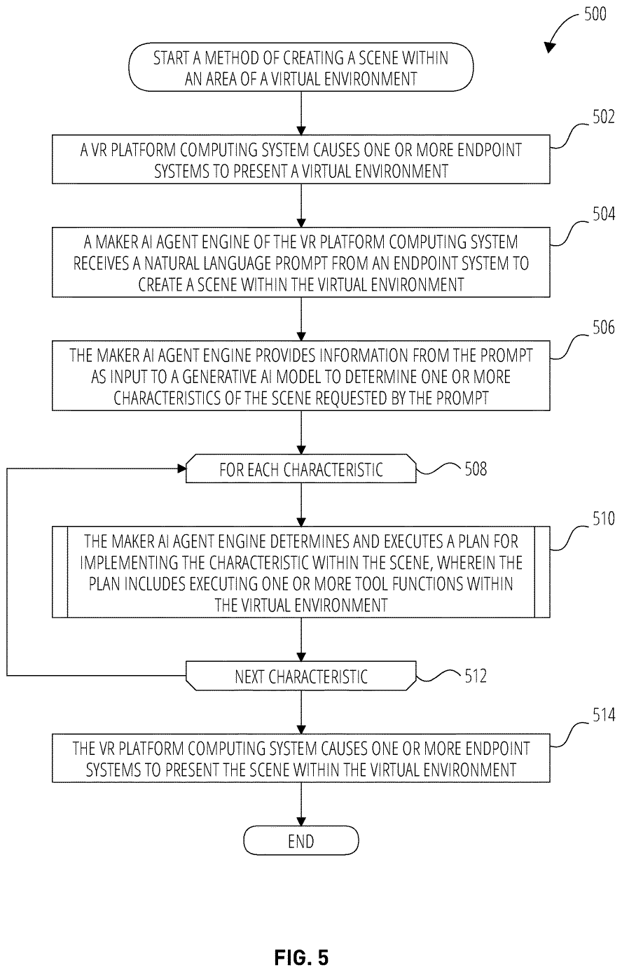

FIG. 5 is a flowchart that illustrates a non-limiting example embodiment of a method of creating a scene within an area of a virtual environment, according to various aspects of the present disclosure. In the method 500, a complex scene is generated from a voice prompt using a collection of machine learning models, thereby overcoming the difficulties introduced by the simplistic nature of the input modalities of the endpoint system 301.

From a start block, the method 500 advances to block 502, where a VR platform computing system 402 causes one or more endpoint systems 301 to present a virtual environment. As described above, the presentation of the virtual environment may include a display of a first-person view associated with each endpoint system 301 of the virtual environment, and may include objects, avatars of other users, and/or other virtual objects.

At block 504, a maker AI agent engine 410 of the VR platform computing system 402 receives a natural language prompt from an endpoint system 301 to create a scene within the virtual environment. In some embodiments, the prompt may be received via voice input detected by the microphone 310 upon actuation of an interface element that directs voice input to the maker AI agent functionality. In some embodiments, the maker AI agent engine 410 may receive a copy of the voice input itself. In some embodiments, the maker AI agent engine 410 may receive a text transcription of the voice input generated by the endpoint system 301 (or another device). Various types of prompts may be provided that are intended to create scenes with various types of objects. Some non-limiting examples of prompts provided by voice inputs may include commands to create one or more objects (e.g., “I'd like to play a racing game. Make an oval track, and put three cars on it.”), commands to change one or more objects (e.g., “Those cars are OK, but they're too big. Can you change them into go karts?”), commands to change the overall environment of the scene (e.g., “This park is nice, but I was thinking of a different mood. Can you make it look like a spooky nighttime scene?”), commands to change behavior of an object (e.g., “One of these cars should be driveable by me, and the other two should race me around the track.”), or other types of commands.

At block 506, the maker AI agent engine 410 provides information from the prompt as input to a generative AI model to determine one or more characteristics of the scene requested by the prompt. Unlike previous technologies where natural language processing techniques would be used to find various parts of speech to match them up with pre-defined commands to be implemented, the use of generative AI models such as LLMs provides the ability to service novel prompts for which no pre-configured behavior has been defined. The one or more determined characteristics may be considered a multi-step plan for servicing the request represented by the prompt, with each characteristic being considered a general task that may be accomplished by invoking one or more tool functions as described below. In some embodiments, a given characteristic determined by the generative AI model may include sub-characteristics. For example, a complex characteristic may include multiple different objects, each of which may be processed separately as a different characteristic of the overall scene (e.g., a “forest” characteristic may include multiple “tree” characteristics). In some embodiments, instead of being categorized as sub-characteristics, such complex creations may simply be created as a plurality of characteristics at the same level.

Depending on the capabilities and configuration of the generative AI model used, the maker AI agent engine 410 may provide a text transcript of a voice prompt to the generative AI model, or may provide a recording of the voice prompt itself. In some embodiments, the maker AI agent engine 410 may also provide additional input to the generative AI model, including but not limited to screenshots or other representations of the virtual environment, a programmatic state of the virtual environment, and/or other information. In some embodiments, the input to the generative AI model may include further context to tailor the output of the model. For example, the input may include further description of the task, such as, “you are an AI-based assistant for creating scenes within a virtual environment. Review the following prompt and determine a set of characteristics that would be present in the scene described by the prompt.” Any suitable type of generative AI model may be used. For example, in some embodiments, a commercially available foundation model (e.g., an LLM such as GPT, Gemini, Llama, Claude, etc.) may be used as the generative AI model.

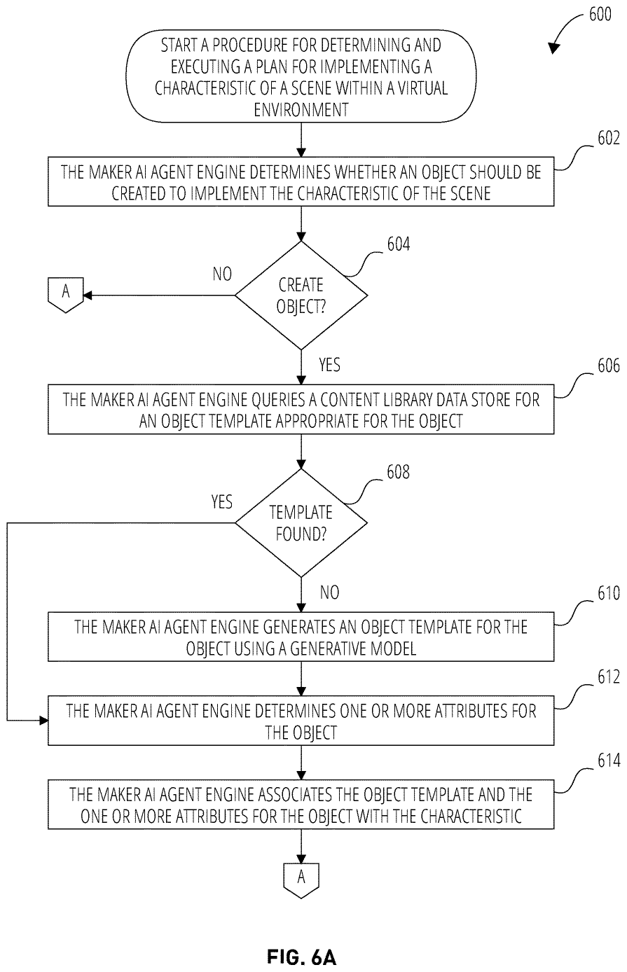

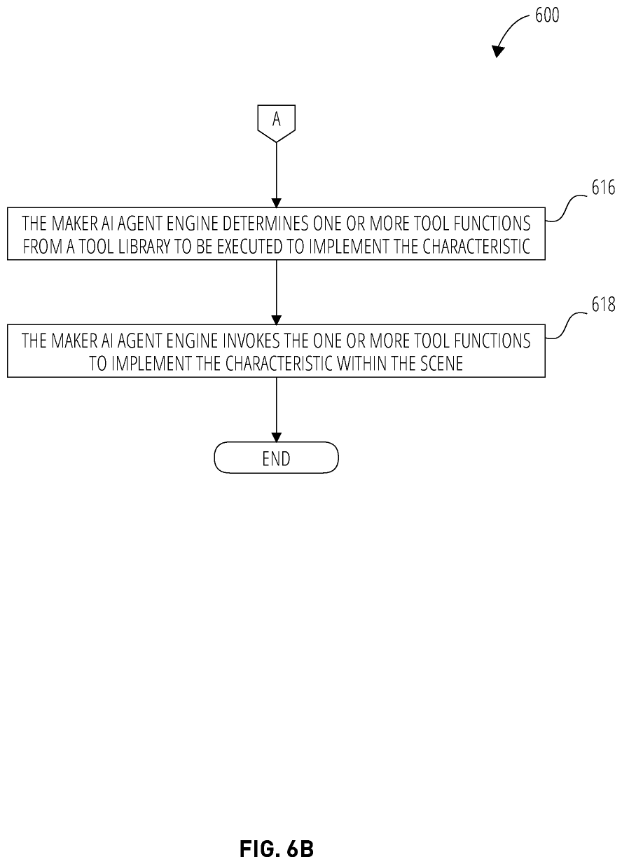

The method 500 then proceeds to a for-loop defined between a for-loop start block 508 and a for-loop end block 512, wherein each characteristic of the scene is processed. From the for-loop start block 508, the method 500 advances to subroutine block 510, where a procedure is executed wherein the maker AI agent engine 410 determines and executes a plan for implementing the characteristic within the scene, wherein the plan includes executing one or more tool functions within the virtual environment. Any suitable procedure may be used, including but not limited to the procedure 600 illustrated in FIGS. 6A-6B and described in detail below.

The method 500 then advances to the for-loop end block 512. If further characteristics remain to be processed, then the method 500 returns to the for-loop start block 508 to process the next characteristic. Otherwise, if all of the characteristics have been processed, then the method 500 advances to block 514. At block 514, the VR platform computing system 402 causes one or more endpoint systems 301 to present the scene within the virtual environment. Once the procedure 600 is executed, the characteristics will have been implemented within the virtual environment as managed by the VR platform computing system 402, and so once each endpoint system 301 is updated to present the current state of the virtual environment, the created scene will be presented.

The method 500 then proceeds to an end block and terminates.

FIGS. 6A-6B are a flowchart that illustrates a non-limiting example embodiment of a procedure for determining and executing a plan for implementing a characteristic of a scene within a virtual environment, according to various aspects of the present disclosure. The procedure 600 is a non-limiting example of a procedure suitable for use at subroutine block 510 of FIG. 5. In the procedure 600, a plan for implementing the characteristic is created and then executed by the maker AI agent engine 410.

From a start block, the procedure 600 advances to block 602, where the maker AI agent engine 410 determines whether an object should be created to implement the characteristic of the scene. In some embodiments, the maker AI agent engine 410 may submit the prompt to a generative AI model with a request to determine whether an object should be created to service the prompt. Generative AI models such as LLMs are highly capable of extracting meaning from text, and so can determine in general whether the prompt includes language that refers to an object that already exists (e.g., “make that car bigger,” “I like that chair but it would be better if it was red,” etc.), language that relates to creating objects (e.g., “make a chair and put it over in the corner,” “I want to play a game of dodgeball in a forest,” etc.), or language that does not reference a specific object (e.g., “it's too bright in here, turn down the lights!”, etc.). If the generative AI model determines that the prompt for the characteristic relates to creating a new object instead of referring to an existing object or to no specific object, then the maker AI agent engine 410 determines that an object should be created. As with the other generative AI models described above, any suitable model may be used, including but not limited to commercially available LLMs.

The procedure 600 then advances to a decision block 604, where a decision is made based on the determination of whether an object should be created. If it was determined that an object should not be created, then the result of decision block 604 is NO, and the procedure 600 advances to a continuation terminal (“terminal A”). Otherwise, if it was determined that an object should be created, then the result of decision block 604 is YES, and the procedure 600 advances to block 606.

At block 606, the maker AI agent engine 410 queries a content library data store 416 for an object template appropriate for the object. In some embodiments, object templates stored in the content library data store 416 may be stored along with plain text descriptions of the associated objects and/or their behaviors. For example, a “car” object may be stored in the content library data store 416 with a description such as “a race car” or “a four-door sedan with two front seats and three rear seats.” By storing the object templates in this way, the maker AI agent engine 410 is able to use a retrieval-augmented generative model (RAG) to search for appropriate object templates related to the prompt. For example, if the prompt includes a request like, “make a racing game with three cars,” a retrieval-augmented generative model would be able to determine that the car object template described as “a race car” is more likely to be relevant to the prompt than the car object template described as “a four-door sedan.” Using retrieval-augmented generative models for search instead of more traditional keyword-based searching allows the maker AI agent to provide a richer experience to the user, at least because the maker AI agent can adapt more easily to complex prompts that do not specifically match keywords by which the object templates may be indexed.

The procedure 600 then advances to decision block 608, where a decision is made based on whether the maker AI agent engine 410 was able to find an appropriate object template for the object in the content library data store 416. If the maker AI agent engine 410 was not able to find an appropriate object template, then the result of decision block 608 is NO, and the procedure 600 advances to block 610. At block 610, the maker AI agent engine 410 generates an object template for the object using a generative model. In some embodiments, the maker AI agent engine 410 may choose an appropriate helper GenAI model 412 to be invoked to create the object template. For example, the user may submit a request such as “Put a painting of a dog on the wall,” which would lead to a characteristic such as “a painting of a dog.” For such a specific request, the content library data store 416 might not have an object that satisfies this search to a high enough degree of confidence. Accordingly, at block 610, the maker AI agent engine 410 may then select a helper GenAI model 412 capable of generating images, such as DALL-E or other image generation model, to generate an image of a dog, and may use another helper GenAI model 412 to create an object template to which the image of the dog can be applied to appear like a painting.

The procedure 600 then advances from block 610 to block 612. If the maker AI agent engine 410 was able to find an appropriate object template, then the result of decision block 608 is YES, and the decision block 608 advances directly from decision block 608 to block 612, using the retrieved object template instead of the generated object template.

At block 612, the maker AI agent engine 410 determines one or more attributes for the object. Attributes for the object may include a size, a location, an orientation, and/or other attributes common to objects within the virtual environment. In some embodiments, the attributes may be based on other objects within the virtual environment. The maker AI agent engine 410 may be provided with enough information regarding the context of the virtual environment to understand the size, locations, and orientations of existing objects with respect to the viewpoint of the user, and the maker AI agent engine 410 may use an LLM (or other generative model) to determine appropriate values for the attributes based on the attributes of the existing objects. For example, the maker AI agent engine 410 may be provided with the locations and sizes of walls of a room in which the user is positioned within the virtual environment, and so if the prompt was to “put a painting of a dog on the wall,” the maker AI agent engine 410 may consider the size of the wall to determine an appropriate size for the painting object (e.g., 40% of the height of the wall, or some other suitable proportion), and may determine a location and orientation that would position the object template on the wall. In some embodiments, the object template may include specific attributes. Some non-limiting examples of specific attributes may include a color for a specific part, a maximum speed, a behavior setting, and/or any other types of attributes. The specific attributes may be described in the plain text description of the object template, and the maker AI agent engine 410 may be configured to determine values for the specific attributes that are thus described.

At block 614, the maker AI agent engine 410 associates the object template and the one or more attributes for the object with the characteristic. For example, the maker AI agent engine 410 may create a representation of the characteristic that references the specific object template and the one or more attributes. For example, the maker AI agent engine 410 may create a representation that states, “create an object using object template #1234 with a size S, a location of {X, Y, Z}, and facing direction T” (with the determined values replacing the italicized variables). In some embodiments, the maker AI agent engine 410 may not determine values for the variables at this point, but may instead fill in the variables using tool functions as described below. For example, the maker AI agent engine 410 may determine that the location should be based on a gaze location of the user or a location of the avatar of the user, and so the variable may be completed using a tool function that can retrieve that information from the appropriate API. In some embodiments, the representation may be provided in plain text as shown here, while in other embodiments, the representation may be provided at least partially in a structured format (e.g., JSON).

The procedure 600 then proceeds to a continuation terminal (“terminal A”). From terminal A (FIG. 6B), the procedure 600 proceeds to block 616, where the maker AI agent engine 410 determines one or more tool functions from a tool library 414 to be executed to implement the characteristic. In some embodiments, tool functions stored in the tool library 414 indicate application programming interface (API) endpoints which may be provided by the VR platform computing system 402 (or other devices) and invoked by the maker AI agent engine 410 in order to make changes within the virtual environment. Some non-limiting examples of actions that may be performed tool functions stored in the tool library 414 include creating a new three-dimensional object within the virtual environment; altering a size, a shape, a location, or a texture of an existing three-dimensional object within the virtual environment; altering a behavior of an existing three-dimensional object within the virtual environment; altering a lighting effect within the virtual environment; determining a location within the virtual environment based on a gaze location; identifying an existing object within the virtual environment based on the gaze location; or determining an appropriate size for an object within the virtual environment based on existing objects within the virtual environment.

As with the object templates stored in the content library data store 416, the tool functions may be stored in the tool library 414 along with a plaintext description of the functionality provided by the tool function, a description of the inputs to the tool function, and a description of the outputs of the tool function. As a non-limiting example, a tool function may be stored with a description such as “This function returns a location in virtual space that the user is looking at,” or “This function accepts as input an identification of an object template, and creates the object described by the object template in the virtual environment using location attributes of the object template.” Similar to the search for object templates, this allows the maker AI agent engine 410 to use a retrieval-augmented generative model to search for appropriate functions to implement the characteristic.

In some embodiments, the maker AI agent engine 410 may provide the object template (if any) associated with the characteristic and the description of the characteristic as input to a retrieval-augmented generative model that has been configured to have its output constrained to valid function calls to tool functions listed in the tool library 414, in order to avoid the problem of hallucinating calls to tool functions that are not supported by the VR platform computing system 402. The output of the retrieval-augmented generative model may be so constrained using any suitable technique, including but not limited to providing an output layer that only outputs calls to tool functions, by providing an additional prompt to the retrieval-augmented generative model that requires the constrained output, or using any other suitable technique.

At block 618, the maker AI agent engine 410 invokes the one or more tool functions to implement the characteristic within the scene. Since the actions at block 616 output a set of calls to tool functions that should be limited to tool functions supported by the VR platform computing system 402, the set of calls to tool functions can simply be invoked by the maker AI agent engine 410 at block 618 to implement the characteristic.

The procedure 600 then advances to an end block and returns control to its caller.

While relatively simple examples of prompts and scenes were described above for ease of discussion, the technology described herein can be used to create quite complex scenes, even just with voice prompts. A non-limiting example of complex scene creation enabled by the present disclosure is as follows:
1. A user submits a voice prompt, “I want a spooky forest scene with a bunch of birds in the trees.” (See Block 504).
2. The maker AI agent engine 410 determines a multi-step plan that includes (1) characteristics related to the forest; (2) characteristics related to the birds; and (3) a characteristic that indicates a spooky mood. (See Block 506).
3. The maker AI agent engine 410 determines a multi-step plan to create the forest. The maker AI agent engine 410 uses its LLM to understand that a forest includes a lot of trees, which are located on the ground and have different sizes. The multi-step plan for creating the forest includes (1) finding a tree model (see Blocks 606-610); (2) creating a number of copies of the tree model having random sizes between plausible bounds and distributed throughout an area (see Blocks 614-618). The maker AI agent engine 410 is able to find a tree model in the Content library data store 416, and so it outputs a list of tool library 414 invocations to create and distribute the number of tree objects using the tree model having the random sizes.
4. The maker AI agent engine 410 determines a multi-step plan to create the birds. The maker AI agent engine 410 uses its LLM to understand that birds may be flying, on the ground, or in a tree. The multi-step plan for creating the birds includes (1) finding a bird model (see Blocks 606-610); (2) finding appropriate locations for the copies of the bird model within the scene (see Blocks 614-618); and (3) creating a number of copies of the bird model. The maker AI agent engine 410 is able to find a bird model in the content library data store 416, and finds locations within the tree objects that are appropriate for attaching at least some of the birds. The maker AI agent engine 410 outputs a list of tool library 414 invocations to create and distribute the bird objects within the scene.
5. The maker AI agent engine 410 uses its LLM to understand that a spooky mood may be dark and foggy. The maker AI agent engine 410 searches the plaintext descriptions of the tool library 414 and finds that a tool is available to change the mood (see Block 616). The plaintext description explains that the characteristics of the scene that can be changed using the tool library 414 include lighting and fog effects, and provides examples of values that can be provided to the tool library 414. The maker AI agent engine 410 outputs an invocation of the tool library 414 for changing the mood with values that correspond to a spooky mood (see Block 618).

While illustrative embodiments have been illustrated and described, it will be appreciated that various changes can be made therein without departing from the spirit and scope of the invention.

### EXAMPLES

The following numbered paragraphs provide a set of non-limiting example embodiments of the subject matter disclosed herein.
Example 1: A computer-implemented method of creating a scene within an area of a virtual environment, the method comprising: receiving, by a computing system, a natural language prompt to create the scene in the area of the virtual environment; determining, by the computing system, a multi-step plan for creating the scene, wherein the multi-step plan includes: determining, by the computing system, one or more general tasks for creating the scene; and determining, by the computing system, one or more tool invocations for accomplishing each general task of the one or more general tasks; and executing, by the computing system, the one or more tool invocations to accomplish the one or more general tasks, thereby creating the scene within the area of the virtual environment.
Example 2: The computer-implemented method of example 1, wherein determining the one or more general tasks for creating the scene includes: determining two or more object types relevant to the scene described in the natural language prompt; and for each object type of the two or more object types: determining an object template for the object type; and determining one or more locations for copies of the object template.
Example 3: The computer-implemented method of example 2, wherein determining the one or more locations for copies of the object template of a first object type and a second object type of the two or more object types includes: determining one or more locations for copies of the object template of the first object type; and determining one or more locations for copies of the object template of the second object type based on the one or more locations for the copies of the object template of the first object type.
Example 4: The computer-implemented method of any one of examples 2-3, wherein determining the one or more tool invocations for accomplishing each general task of the one or more general tasks includes, for each object type of the two or more object types: querying, by the computing system, a content library for the object template of the object type.
Example 5: The computer-implemented method of example 4, wherein querying the content library for the object template of the object type includes using retrieval-augmented generation to retrieve the object template from the content library based on the natural language prompt.
Example 6: The computer-implemented method of any one of examples 4-5, further comprising: in response to determining that no appropriate object template is present in the content library: generating, by the computing system, the object template using a generative model based on the natural language prompt.
Example 7: The computer-implemented method of any one of examples 4-6, wherein determining the one or more tool invocations for accomplishing each general task of the one or more general tasks includes: providing, by the computing system, at least the object templates for each object type as input to a model configured to output one or more tool invocations based on the input.
Example 8: The computer-implemented method of example 7, wherein the input further includes at least one of the natural language prompt or information regarding a gaze location of a user within the virtual environment.
Example 9: The computer-implemented method of any one of examples 1-8, wherein the natural language prompt is received via a virtual reality user interface device; and wherein the method further comprises presenting the area of the virtual environment using the virtual reality user interface device.
Example 10: A computer-implemented method of creating or updating objects within a virtual environment, the method comprising: receiving, by a computing system, a natural language prompt to create or update an object in the virtual environment; generating, by the computing system, a list of one or more relevant tool functions with inputs based on the natural language prompt; and executing, by the computing system, the list of the one or more relevant tool functions.
Example 11: The computer-implemented method of example 10, wherein each relevant tool function is code that invokes an application programming interface.
Example 12: The computer-implemented method of example 11, wherein generating the list of the one or more relevant tool functions with inputs based on the natural language prompt includes: searching, by the computing system, a tool library, wherein the tool library provides plaintext descriptions for a plurality of tool functions, and wherein the plaintext descriptions include plaintext descriptions of inputs and outputs for each tool function of the plurality of tool functions.
Example 13: The computer-implemented method of any one of examples 11-12, wherein generating the list of the one or more relevant tool functions with inputs based on the natural language prompt includes: providing the natural language prompt as input to a transformer-based machine learning model trained to generate code that invokes the one or more relevant tool functions as output.
Example 14: The computer-implemented method of any one of examples 10-13, wherein each relevant tool function performs an action that includes one or more of: creating a new three-dimensional object within the virtual environment; altering a size, a shape, a location, or a texture of an existing three-dimensional object within the virtual environment; altering a behavior of an existing three-dimensional object within the virtual environment; altering a lighting effect within the virtual environment; determining a location within the virtual environment based on a gaze location; identifying an existing object within the virtual environment based on the gaze location; or determining an appropriate size for an object within the virtual environment based on existing objects within the virtual environment.
Example 15: The computer-implemented method of any one of examples 10-14, wherein the natural language prompt is received via a virtual reality user interface device; and wherein the method further comprises presenting the virtual environment using the virtual reality user interface device.
Example 16: A system, comprising: an endpoint system that includes: a display device; and at least one handheld controller device; wherein the endpoint system is configured to present an area of a virtual environment using the display device; and a VR platform computing system that includes at least one processor and a non-transitory computer-readable medium having computer-executable instructions stored thereon that, in response to execution by the at least one processor, cause the VR platform computing system to perform actions for creating a scene within the area of the virtual environment presented by the endpoint system, the actions comprising: receiving, by the VR platform computing system from the endpoint system, a natural language prompt to create the scene in the area of the virtual environment; determining, by the VR platform computing system, a multi-step plan for creating the scene, wherein the multi-step plan includes: determining, by the VR platform computing system, one or more general tasks for creating the scene; and determining, by the VR platform computing system, one or more tool invocations for accomplishing each general task of the one or more general tasks; and executing, by the VR platform computing system, the one or more tool invocations to accomplish the one or more general tasks, thereby creating the scene within the area of the virtual environment.
Example 17: The system of example 16, wherein determining the one or more general tasks for creating the scene includes: determining two or more object types relevant to the scene described in the natural language prompt; and for each object type of the two or more object types: determining an object template for the object type; and determining one or more locations for copies of the object template.
Example 18: The system of example 17, wherein determining the one or more locations for copies of the object template of a first object type and a second object type of the two or more object types includes: determining one or more locations for copies of the object template of the first object type; and determining one or more locations for copies of the object template of the second object type based on the one or more locations for the copies of the object template of the first object type.
Example 19: The system of any one of examples 17-18, wherein determining the one or more tool invocations for accomplishing each general task of the one or more general tasks includes, for each object type of the two or more object types: querying, by the VR platform computing system, a content library for the object template of the object type; wherein querying the content library for the object template of the object type includes using retrieval-augmented generation to retrieve the object template from the content library based on the natural language prompt.
Example 20: The system of example 19, wherein determining the one or more tool invocations for accomplishing each general task of the one or more general tasks includes: providing, by the VR platform computing system, at least the object templates for each object type as input to a model configured to output one or more tool invocations based on the input.

1. A computer-implemented method of creating a scene within an area of a virtual environment, the method comprising:
receiving, by a computing system, a natural language prompt to create the scene in the area of the virtual environment;
determining, by the computing system, a multi-step plan for creating the scene, wherein the multi-step plan includes:
determining, by the computing system, one or more general tasks for creating the scene; and
determining, by the computing system, one or more tool invocations for accomplishing each general task of the one or more general tasks; and
executing, by the computing system, the one or more tool invocations to accomplish the one or more general tasks, thereby creating the scene within the area of the virtual environment.

2. The computer-implemented method of claim 1, wherein determining the one or more general tasks for creating the scene includes:
determining two or more object types relevant to the scene described in the natural language prompt; and
for each object type of the two or more object types:
determining an object template for the object type; and
determining one or more locations for copies of the object template.

3. The computer-implemented method of claim 2, wherein determining the one or more locations for copies of the object template of a first object type and a second object type of the two or more object types includes:
determining one or more locations for copies of the object template of the first object type; and
determining one or more locations for copies of the object template of the second object type based on the one or more locations for the copies of the object template of the first object type.

4. The computer-implemented method of claim 2, wherein determining the one or more tool invocations for accomplishing each general task of the one or more general tasks includes, for each object type of the two or more object types:
querying, by the computing system, a content library for the object template of the object type.

5. The computer-implemented method of claim 4, wherein querying the content library for the object template of the object type includes using retrieval-augmented generation to retrieve the object template from the content library based on the natural language prompt.

6. The computer-implemented method of claim 4, further comprising:
in response to determining that no appropriate object template is present in the content library:
generating, by the computing system, the object template using a generative model based on the natural language prompt.

7. The computer-implemented method of claim 4, wherein determining the one or more tool invocations for accomplishing each general task of the one or more general tasks includes:
providing, by the computing system, at least the object templates for each object type as input to a model configured to output one or more tool invocations based on the input.

8. The computer-implemented method of claim 7, wherein the input further includes at least one of the natural language prompt or information regarding a gaze location of a user within the virtual environment.

9. The computer-implemented method of claim 1, wherein the natural language prompt is received via a virtual reality user interface device; and
wherein the method further comprises presenting the area of the virtual environment using the virtual reality user interface device.

10. A computer-implemented method of creating or updating objects within a virtual environment, the method comprising:
receiving, by a computing system, a natural language prompt to create or update an object in the virtual environment;
generating, by the computing system, a list of one or more relevant tool functions with inputs based on the natural language prompt; and
executing, by the computing system, the list of the one or more relevant tool functions.

11. The computer-implemented method of claim 10, wherein each relevant tool function is code that invokes an application programming interface.

12. The computer-implemented method of claim 11, wherein generating the list of the one or more relevant tool functions with inputs based on the natural language prompt includes:
searching, by the computing system, a tool library, wherein the tool library provides plaintext descriptions for a plurality of tool functions, and wherein the plaintext descriptions include plaintext descriptions of inputs and outputs for each tool function of the plurality of tool functions.

13. The computer-implemented method of claim 11, wherein generating the list of the one or more relevant tool functions with inputs based on the natural language prompt includes:
providing the natural language prompt as input to a transformer-based machine learning model trained to generate code that invokes the one or more relevant tool functions as output.

14. The computer-implemented method of claim 10, wherein each relevant tool function performs an action that includes one or more of:
creating a new three-dimensional object within the virtual environment;
altering a size, a shape, a location, or a texture of an existing three-dimensional object within the virtual environment;
altering a behavior of an existing three-dimensional object within the virtual environment;
altering a lighting effect within the virtual environment;
determining a location within the virtual environment based on a gaze location;
identifying an existing object within the virtual environment based on the gaze location; or
determining an appropriate size for an object within the virtual environment based on existing objects within the virtual environment.

15. The computer-implemented method of claim 10, wherein the natural language prompt is received via a virtual reality user interface device; and
wherein the method further comprises presenting the virtual environment using the virtual reality user interface device.

16. A system, comprising:
an endpoint system that includes:
a display device; and
at least one handheld controller device;
wherein the endpoint system is configured to present an area of a virtual environment using the display device; and
a VR platform computing system that includes at least one processor and a non-transitory computer-readable medium having computer-executable instructions stored thereon that, in response to execution by the at least one processor, cause the VR platform computing system to perform actions for creating a scene within the area of the virtual environment presented by the endpoint system, the actions comprising:
receiving, by the VR platform computing system from the endpoint system, a natural language prompt to create the scene in the area of the virtual environment;
determining, by the VR platform computing system, a multi-step plan for creating the scene, wherein the multi-step plan includes:
determining, by the VR platform computing system, one or more general tasks for creating the scene; and
determining, by the VR platform computing system, one or more tool invocations for accomplishing each general task of the one or more general tasks; and
executing, by the VR platform computing system, the one or more tool invocations to accomplish the one or more general tasks, thereby creating the scene within the area of the virtual environment.

17. The system of claim 16, wherein determining the one or more general tasks for creating the scene includes:
determining two or more object types relevant to the scene described in the natural language prompt; and
for each object type of the two or more object types:
determining an object template for the object type; and
determining one or more locations for copies of the object template.

18. The system of claim 17, wherein determining the one or more locations for copies of the object template of a first object type and a second object type of the two or more object types includes:
determining one or more locations for copies of the object template of the first object type; and
determining one or more locations for copies of the object template of the second object type based on the one or more locations for the copies of the object template of the first object type.

19. The system of claim 17, wherein determining the one or more tool invocations for accomplishing each general task of the one or more general tasks includes, for each object type of the two or more object types:
querying, by the VR platform computing system, a content library for the object template of the object type;
wherein querying the content library for the object template of the object type includes using retrieval-augmented generation to retrieve the object template from the content library based on the natural language prompt.

20. The system of claim 19, wherein determining the one or more tool invocations for accomplishing each general task of the one or more general tasks includes:
providing, by the VR platform computing system, at least the object templates for each object type as input to a model configured to output one or more tool invocations based on the input.
